(19) United States
(12) Patent Application Publication
(10) Pub. No.: US 2006/0171668 A1
(43) Pub. Date: Aug. 3, 2006

(54) Image recorder/player and auto titling method

(75) Inventor: Jin Whi Kim, Suwon-Si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/253,554

(22) Filed: Oct. 20, 2005

(30) Foreign Application Priority Data
Jan. 31, 2005 (KR) 2005-8768

(51) Int. Cl. H04N 5/91

(52) U.S. Cl. 386/83

(57) ABSTRACT

A video recorder/player and an auto titling method where, if a recording of a received broadcast signal is started, a program name is extracted from the broadcast signal, and the extracted program name is stored as a title in a storage medium. A program name is continually extracted from the broadcast signal while the recording is in progress, and the extracted program name is compared with the stored program name to determine whether or not a new program is received. If a new program is received, the new program is recorded under a new title, which is different from the previously stored title, in the storage medium, and the extracted program name corresponding to the new program is recorded in the storage medium as the new title.

### CROSS-REFERENCE TO RELATED APPLICATION

This application claims the benefit under 35 U.S.C. §119(a) from Korean Patent Application No. 2005-8768, filed on Jan. 31, 2005 min the Korean Intellectual Property Office, the entire disclosure of which is hereby incorporated by reference.

### BACKGROUND OF THE INVENTION

1. Field of the Invention

The present invention relates to a video recorder/player and an auto titling method. More particularly, the present invention relates to a video recorder/player and an auto titling method wherein, when a plurality of programs are recorded via a single record operation, the programs are automatically divided by individual titles so that the user may, for example, easily confirm which programs have been recorded on the DVD disc.

2. Description of the Related Art

As disclosed in Korean Patent Publication No. 2003-0067248, a DVD recorder, which is a type of video recorder/player, generally comprises A/V encoder and decoder modules for encoding and decoding video and audio signals into and from MPEG-2 format, a loader engine including a Hard Disk Drive (HDD), which is a large-volume storage medium, and a DVD drive, and a microprocessor for controlling each element of the DVD recorder.

The DVD recorder stores video and audio signals received through inputs on the HDD or a DVD disc in a recording mode. After the video and audio signals are stored, the DVD recorder displays a title guidance screen for providing title information stored in the DVD disc on a display of a TV connected to the DVD recorder at the request of the user.

However, when recording a plurality of programs via a single record operation, the conventional DVD recorder records the programs under one title, stores a program name of only the first recorded program as the title, and then displays the recorded program name on the title guidance screen, thereby making it difficult for the user to determine which programs are included under the recorded title. For example, when recording a plurality of programs (i.e., Inside Economics 1, SBS Night Line 2, Sports Wide 3, and Cine Club 4) via a single record operation as shown in FIG. 1, the conventional DVD recorder records the programs under one title, stores the corresponding title, which according to this example is Inside Economics 1, and then displays the stored title (Inside Economics 1) on the title guidance screen. This makes it difficult for the user to determine whether or not other programs (SBS Night Line 2, Sports Wide 3, and Cine Club 4) have been recorded.

### SUMMARY OF THE INVENTION

Therefore, it is an exemplary aspect of the present invention to provide a video recorder/player and an auto titling method, wherein, when a number of programs are recorded via a single record operation, the programs are recorded under individual titles so that sufficient information of each of the programs may be displayed as needed.

Additional exemplary aspects and/or advantages of the present invention will be set forth in part in the following description of the exemplary embodiments of the present invention and, in part, may be appreciated, or learned through practice, by skilled artisans from the description of the exemplary embodiments of the present invention.

In accordance with exemplary implementations of the present invention, the above exemplary and/or other aspects of the present invention maybe achieved by the provision of an auto titling method for a video recorder/player, the method comprising: if a recording of a broadcast signal has started, extracting a program name carried in the broadcast signal, and storing the extracted program name as a title in a storage medium; continually extracting program name(s) carried in the broadcast signal while the recording is in progress, and comparing the extracted program name with the previously stored program name to determine whether or not a new program is received; and, if a new program is received, recording the new program under a new title, which is different from the stored title corresponding to the stored program name, in the storage medium, and recording the extracted new program name corresponding to the new program, as the new title name in the storage medium.

### BRIEF DESCRIPTION OF THE DRAWINGS

These and/or other exemplary aspects and advantages of the exemplary embodiments of the present invention will become apparent and more readily appreciated from the following description of the exemplary embodiments, taken in conjunction with the accompanying drawings, in which like reference symbols indicate the same or similar components, wherein:

FIG 1 is a diagram illustrating a plurality of TV programs that are recorded via a single record operation;

FIG 2 is a block diagram of a DVD recorder according to an exemplary embodiment of the present invention;

FIG 3 is a flow chart of an exemplary implementation of an auto titling method for the DVD recorder shown, for example, in FIG. 2 according to an exemplary implementation of the present invention; and

FIG 4 is a diagram illustrating an example of a title guidance screen, according to an embodiment of the present invention, that may be displayed on, for example, a TV screen connected to, for example, a DVD recorder shown in, for example, FIG. 2 to allow the user to confirm which titles have been recorded on a DVD disc when a plurality of programs have been recorded on the DVD disc.

### DETAILED DESCRIPTION OF EXEMPLARY EMBODIMENTS

Reference will now be made in detail to the exemplary embodiments of the present invention, examples of which are illustrated in the accompanying drawings, wherein, as noted above, like reference numerals refer to the like elements throughout. The exemplary embodiments of the present invention are described below so to explain the exemplary implementations of the present invention with reference to the drawing figures.

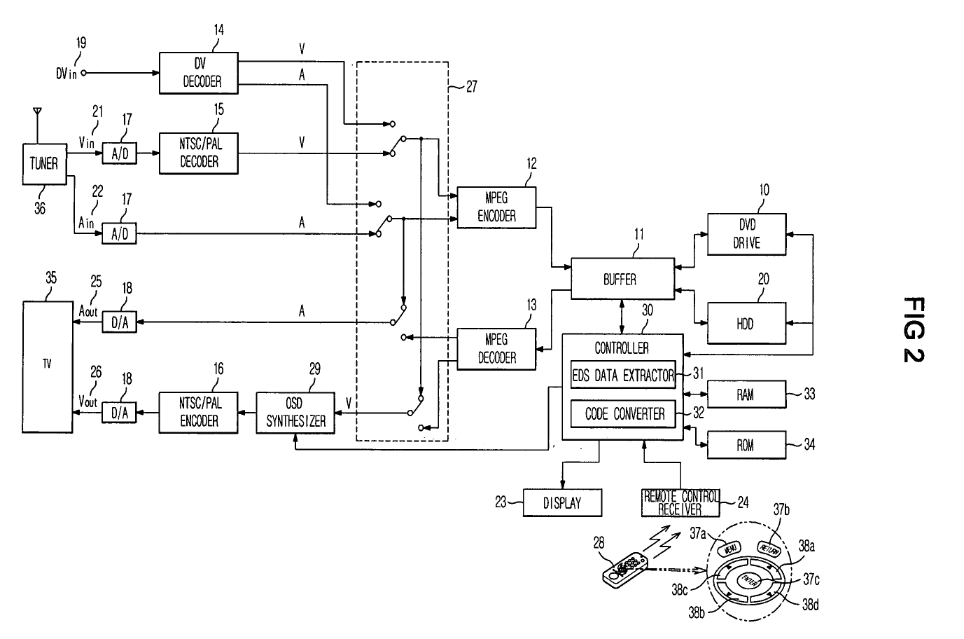

As shown in FIG. 2, a DVD recorder according to an exemplary embodiment of the present invention comprises a plurality of inputs 19, 21 and 22, a plurality of outputs 25 and 26, a plurality of AID converters 17, a plurality of D/A converters 18, a DV decoder 14, an NTSC/PAL decoder 15, and an NTSC/PAL encoder 16. The DVD recorder also comprises a switching circuit 27, an MPEG encoder 12, an MPEG decoder 13, a controller 30, an On Screen Display (OSD) synthesizer 29, a buffer 11, a DVD drive 10, and an HDD 20. The DVD recorder further comprises a display unit 23, a remote control receiver 24, a RAM 33, and a ROM 34.

The inputs of the DVD recorder include a digital interface terminal (Dvin) 19, a video input (Vin) 21, and an audio input (Ain) 22. AV data in digital video (DV) format is input to the digital interface terminal 19. Video signals in NTSC or PAL format received from a tuner 36 or a set-top box are input to the video input 21, and audio signals received from the tuner 36 or the set-top box are input to the audio input 22.

The outputs of the DVD recorder include a video output (Vout) 25 and an audio output (Aout) 26. The video output 26 outputs video signals in NTSC or PAL format to the TV 35 connected to the video output 26, and the audio output 25 outputs audio signals to the TV 35 connected to the audio output 25.

The DV decoder 14 converts AV data in digital video format received through the digital interface terminal 19 into video and audio signals in International Telecommunication Union (ITU)-R BT format. The NTSC/PAL decoder 15 converts a video signal in NTSC or PAL format received through the video input 21 into a video signal in ITU-R BT format. The NTSC/PAL encoder 16 converts a video signal in ITU-R BT format output from the MPEG decoder 13 into a video signal in NTSC or PAL format.

The switching circuit 27 allows a video signal output from the NTSC/PAL decoder 15 to be transferred to the MPEG encoder 12 and the OSD synthesizer 29, and allows an audio signal received through the audio input (Ain) 22 to be transferred to the MPEG encoder 12 and the audio output (Aout) 25. When, AV data in digital video format is recorded, the switching circuit 27 allows a video signal output from the DV decoder 14 to be transferred to the MPEG encoder 12 and the OSD synthesizer 29, and allows an audio signal output from the DV decoder 14 to be transferred to the MPEG encoder 12 and the audio output (Aout) 25. On the other hand, when AV data is played back, the switching circuit 27 allows a video signal output from the MPEG decoder 13 to be transferred to the OSD synthesizer 29, and allows an audio signal output from the MPEG decoder 13 to be transferred to the audio output (Auot) 25.

The MPEG encoder 12 compresses and encodes, using the MPEG-2 standard, a video signal in ITU-R BT format and a digitized audio signal to generate an AV data stream. Conversely, the MPEG decoder 13 converts an AV data stream into a video signal in ITU-R BT format.

The controller 30 includes an EDS data extractor 31 for extracting Extended Data Service (EDS) data from a TV signal, and a code converter 32 for converting a program name contained in EDS data into an ASCII code or restoring the program name from the ASCII code.

EDS data includes channel-related service data, program-related service data, and other service data. The channel-related service data includes a broadcast station name, a local broadcast station name, a local channel number, and the like. The program-related service data includes a program name, a program type, a program rating, voice-related information, a total program time, a remaining program amount, and the like. The other service data includes the current time, weather information, and the like. EDS data is carried in 10th to 21st scan lines in the vertical blanking interval of a TV signal (in the case of NTSC). More specifically, EDS data is carried in the scan lines other than the 21st scan line in which caption broadcasts are carried. Accordingly, the EDS data extractor 31 checks 10th to 21st scan lines of a TV signal received from the buffer 11 to extract EDS data therefrom. The code converter 32 converts a program name, which is text included in the EDS data extracted by the EDS data extractor 31, into an ASCII code, or restores a program name from an ASCII code stored in a DVD disc or the HDD 20.

The controller 30 controls each element of the DVD recorder. The controller 30 produces an OSD image for display on the TV 35 connected to the DVD recorder, and provides the produced OSD image to the OSD synthesizer 29. The OSD synthesizer 29 then allows the OSD image received from the controller 30 to be displayed on the TV 35. The buffer 11 temporarily stores an AV data stream. The DVD drive 10 writes or reads AV data to or from a DVD disc loaded in the DVD drive 10. The HDD 20 stores various data, independently of the DVD drive 10.

The remote control receiver 24 receives a signal transmitted from a remote controller 28 and transfers it to the controller 30. The remote controller 28 includes a menu button 37a used to display or close a menu screen on the TV 35 connected to the DVD recorder, a return button 37b used to return the current screen to a previous screen, an enter button 37c used to select an item, and up, down, left, and right navigation buttons 38a, 38b, 38c, and 38d used to move between items displayed on the screen.

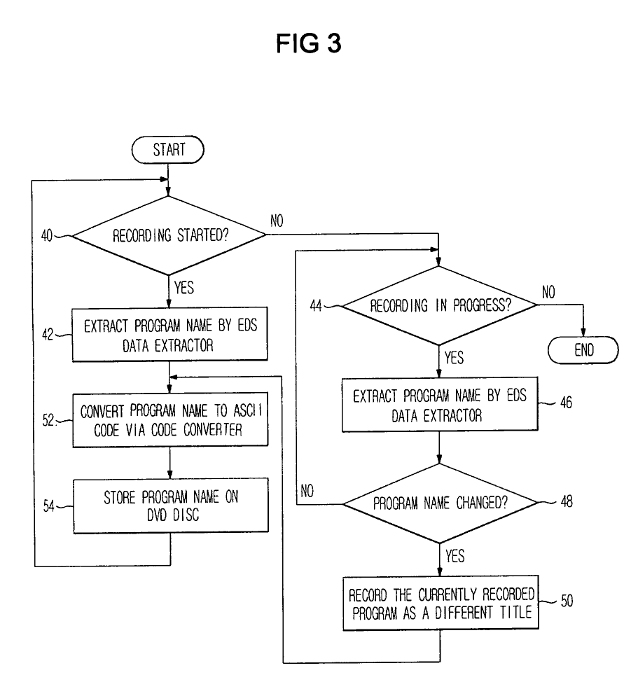

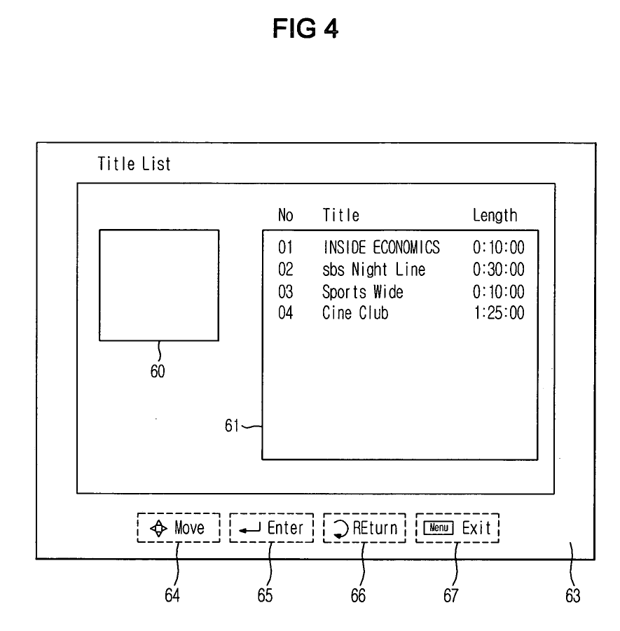

A program name record operation of the DVD recorder shown in FIG. 2 will now be described with reference to FIGS. 3 and 4. To record a TV signal, the user presses the menu button 37a on the remote controller 28 to display a number of menu items (for example, record, playback and setup items), and selects a recording item of the displayed menu items to set programmed recording or immediately start recording.

The controller 30 determines whether or not recording is started (40), and controls the tuner 36 to receive a TV signal of a channel set by the user if the recording is started. A video signal received through the tuner 36 is stored in the DVD drive 10 and the HDD 20 via the NTSC/PAC decoder 15, the MPEG encoder 12, and the buffer 11.

The received TV signal is also transmitted to the controller 30, and the EDS data extractor 31 in the controller 30 extracts EDS data, which contains a program name, from the TV signal (42). The code converter 32 converts the program name into an ASCII code (52).

The controller 30 transmits the ASCII code, produced through the conversion of the program name, back to the buffer 11, so that the program name is stored, as a title, in a DVD disc or the HDD 20 (54). When the DVD drive 10 stores the program name as a title in a DVD disc, the DVD drive 10 stores the title in Video Manager Information (VMGI) of the DVD disc, more specifically in a Text Data Manager (TXTDT_MG) area thereof. VMGI is navigation data located at the start or end of Video Manager (VMG) that is data to control at least one Video Title Set (VTS) and Video Manger Menu (VMGM).

If the first extracted program name is recorded, as a title, on the DVD disc, the controller 30 again determines whether or not recording is started. If recording is not started, the controller 30 determines whether recording is in progress (44). If recording is not in progress, the controller 30 terminates the procedure. If recording is in progress, the EDS data extractor 31 in the controller 30 extracts EDS data, which contains a program name, from the TV signal as at step 42 (46). Then, the controller 30 compares the program name extracted at step 46 with the previously extracted program name (i.e., the first extracted program name) to determine whether or not the program name has changed (48).

If the first extracted program name is identical to the program name extracted at step 46, the controller 30 returns to step 44 to store the currently recorded program under the same title as that of the program recorded when the recording started. If the two program names are not identical, the controller 30 records the currently recorded program as a new title, different from that of the program recorded when the recording started (50).

Conventionally, if no action is taken when a plurality of programs are recorded via a single record operation, the programs are recorded as a single title. However, according to an exemplary embodiment of the present invention, the programs are recorded under different titles. To accomplish this, according to an exemplary implementation of the present invention, if it is determined that the program name carried in the TV signal has changed, the controller 30 allows for a new title to be generated in a Video Title Set (VTS)when the TV signal is recorded on the DVD disc. Then, the controller 30 allows the code converter 32 to convert the newly extracted program name into an ASCII code to record it on the DVD disc (or the HDD) 20 (52), and transfers the ASCII code corresponding to the new program name to the buffer 11 so that it is recorded in the VMGI of the DVD disc (54).

If a plurality of programs are divided by different titles when the programs are recorded via a single record operation and the title names (i.e., the program names) are all recorded in the VMGI as described above, the program names recorded on the DVD disc can be displayed on a title guidance screen so that the user can easily confirm which programs have been recorded on the DVD disc.

Specifically, according to an exemplary embodiment of the present invention, if the user presses the menu button 37a on the remote controller 28 and selects a title list from setup menu items after recording on a DVD disc is completed, the controller 30 reads all title names (i.e., all program names) recorded in VMGI of the DVD disc and displays all of the title names on the TV 35 connected to the DVD recorder (see FIG. 4).

As shown in FIG. 4, a Picture In Picture (PIP) window 60, which displays the first scene of each title, is provided in an upper left portion of the title guidance screen that displays information of titles stored on the DVD disc. A title guidance area 61, which displays a title number, a title name, and a title length of each title, is provided on the right of the PIP window 60. A guidance mark area 63 is provided on the screen at a lower portion thereof. The guidance mark area 63 includes a Move mark 64 indicating whether or not the cursor moves between items displayed on the screen, an Enter mark 65 indicating whether or not an item, at which the cursor is located, is selected, a Return mark 66 indicating whether or not the current screen is changed to the previous screen, and an Exit mark 67 whether or not the current screen is terminated.

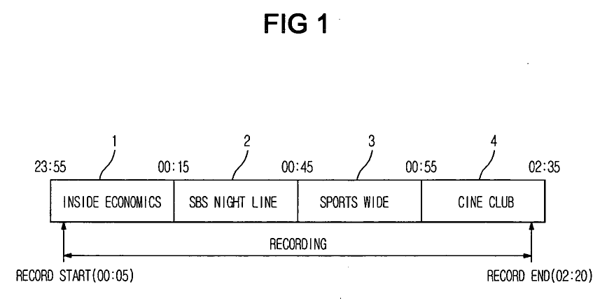

According to an exemplary embodiment of the present invention, all program names of a plurality of programs, which were stored when the plurality of programs were recorded via a single record operation, are displayed as titles, together with respective title lengths (i.e., program lengths), on the title guidance area of FIG. 4. For example, when a plurality of programs (i.e., Inside Economics 1, SBS Night Line 2, Sports Wide 3, and Cine Club 4) are recorded via a single record operation as shown in FIG. 1, only the title name of Inside Economics 1 and the total title length (2 hours and 15 minutes) are displayed in the conventional DVD recorder. However, according to an exemplary embodiment of the present invention, respective program names of Inside Economics 1, SBS Night Line 2, Sports Wide 3, and Cine Club 4 are displayed together with respective program lengths. That is, according to an exemplary implementation of the present invention, if a number of programs are recorded via a single record operation, the programs are handled under individual titles and program names of the programs are recorded as titles, and the recorded titles are then displayed on the title guidance area 61.

Although the above exemplary embodiments of the present invention have been described for the DVD recorder as an example, exemplary implementations of the present invention can be applied not only to the DVD recorder but also to various other video recorders/players such as DVDNVCR combos.

As is apparent from the above description, exemplary implementations of the prevent invention provide a video recorder/player and an auto titling method wherein, when a plurality of programs are recorded via a single record operation, the programs are recorded under individual titles and a title guidance screen providing respective information of the recorded programs is displayed at the request of the user so that the user can easily confirm which programs have been recorded.

Although a few exemplary embodiments of the present invention have been shown and described, it would be appreciated by those skilled in the art that changes and-variations may be made without departing from the principles and spirit of the invention, the scope of which is defined in the claims and their equivalents.

What is claimed is:

1. An auto titling method for a video recorder/player, the method comprising:
extracting a first program name carried in a broadcast signal, and storing the first program name as a first title in a storage medium;
extracting a second program name carried in the broadcast signal while the recording is in progress, and comparing the second program name with the first program name to determine whether or not a new program is received; and
if the new program is received, recording the new program under a second title different from the first title in the storage medium, and recording the second program name corresponding to the new program as the second title in the storage medium.

2. The auto titling method according to claim 1, wherein Extended Data Service (EDS) data carriedin the broadcast signal comprises the program name.

3. The auto titling method according to claim 1, further comprising:
converting the program name to an ASCII code; and
recording the ASCII code in the storage medium.

4. The auto titling method according to claim 1, wherein the broadcast signal comprises a TV signal, and the program name comprises a TV program name.

5. An auto titling method for a video recorder/player, the method comprising:
extracting a program name carried in a broadcast signal, and storing a first title comprising the extracted program name in a storage medium;
if the program name is changed while a recording is in progress, recording a program corresponding to the changed program name under a second title in the storage medium, the second title comprising the changed program name; and
displaying at least the first title and the second title stored in the storage medium on a title guidance screen.

6. The auto titling method according to claim 5, wherein, if a plurality of programs are recorded in the recording, respective title information of the plurality of programs are displayed on the title guidance screen in the order in which the programs are recorded.

7. A video recorder/player comprising:
a receiver for receiving a broadcast signal;
a recording unit for recording the broadcast signal on a storage medium; and
a controller comprising an EDS extractor for extracting EDS data carried in the broadcast signal, wherein the controller determines whether or not a new program different from a previous program is received while the recording is in progress, and, if the new program different from the previous program is received, the controller controls the recording unit to record in the storage medium the new program under a second title different from a first title corresponding to the previous program.

8. The video recorder/player according to claim 7, wherein, the determining whether or not the new program different from a previous program is received comprises determining if a program name carried in the broadcast signal is changed, and
wherein, if the controller determines that the program name is changed, the controller determines that the new program is received, and controls the recording unit to record the changed program name in the storage medium, the second title comprising the changed program name.

9. The video recorder/player according to claim 8, further comprising a code converter for converting the program name to an ASCII code to be recorded in the storage medium.

10. The auto titling method according to claim 1, wherein the extracting comprises continually extracting a program name and comparing the extracted program name with a program name stored in the storage medium to determine whether or not the new program is received.

11. The auto titling method according to claim 1, wherein the extracting is performed if recording of the broadcast signal is started.

12. The auto titling method according to claim 5, wherein the extracting is performed if recording of the broadcast signal is started.

13. The auto titling method according to claim 5, wherein the first title is different from the second title.

14. The auto titling method according to claim 5, wherein the displaying comprises displaying after the recording is completed.
